(19) United States
(12) Patent Application Publication
(10) Pub. No.: US 2025/0385057 A1
(43) Pub. Date: Dec. 18, 2025

(54) PRESSING OPERATION BODY, SWITCH MODULE, AND ELECTRONIC DEVICE

(71) Applicant: ALPS ALPINE CO., LTD., Tokyo (JP)

(72) Inventor: Hiroshi OHARA, Miyagi (JP)

(21) Appl. No.: 19/245,867

(22) Filed: Jun. 23, 2025

Related U.S. Application Data
(63) Continuation of application No. PCT/JP2023/039499, filed on Nov. 1, 2023.

(30) Foreign Application Priority Data
Dec. 26, 2022 (JP) 2022-208484

(51) Int. Cl. H01H 13/14

(52) U.S. Cl. CPC H01H 13/14

(57) ABSTRACT

A pressing operation body composed of a metal material includes: a base; an elastic arm connected to the base; and a top part provided above the base, supported by the elastic arm, and configured to be movable toward the base by being pressed. The base includes a landing portion configured to be fixed to an installation part on which the pressing operation body is to be installed, a wall portion extending upward from the landing portion, and a contact surface supported by the wall portion from below and configured to contact the top part when the top part is pressed.

### CROSS-REFERENCE TO RELATED APPLICATIONS

This application is a continuation of International Application No. PCT/JP2023/039499, filed on Nov. 1, 2023 and designating the U. S., which claims priority to Japanese Patent Application No. 2022-208484, filed on Dec. 26, 2022. The contents of these applications are incorporated herein by reference in their entirety.

### BACKGROUND OF THE INVENTION

### 1. Field of the Invention

The present disclosure relates to a pressing operation body, a switch module, and an electronic device.

### 2. Description of the Related Art

International Publication No. WO2022/092292 (hereinafter “Patent Document 1”) describes an electronic component provided in an electronic device. The electronic component includes a pressing member provided above a switch, having a pressing surface, and including a pair of leg members extending from the pressing surface. When an operation member is pressed, the pressing surface presses the switch while the pair of leg members are elastically deformed.

### SUMMARY OF THE INVENTION

According to an embodiment of the present disclosure, a pressing operation body composed of a metal material includes: a base; an elastic arm connected to the base; and a top part provided above the base, supported by the elastic arm, and configured to be movable toward the base by being pressed. The base includes a landing portion configured to be fixed to an installation part on which the pressing operation body is to be installed, a wall portion extending upward from the landing portion, and a contact surface supported by the wall portion from below and configured to contact the top part when the top part is pressed.

### BRIEF DESCRIPTION OF THE DRAWINGS

FIG. 1 is a perspective view of the exterior of a switch module according to an embodiment;

FIG. 2 is a plan view of the switch module according to the embodiment;

FIG. 3 is a right side view of the switch module according to the embodiment;

FIG. 4 is a rear view of the switch module according to the embodiment;

FIG. 5 is a cross-sectional view of the switch module according to the embodiment, taken along line A-A;

FIG. 6 is a cross-sectional view of the switch module according to the embodiment, taken along line B-B;

FIGS. 7A and 7B are diagrams illustrating the operation of the switch module according to the embodiment;

FIG. 8 is a bottom view of the switch module according to the embodiment;

FIG. 9 is a diagram illustrating an example of a configuration of an electronic device according to the embodiment; and

FIG. 10 is a perspective view of the exterior of a switch module according to a modification of the embodiment.

### DESCRIPTION OF THE PREFERRED EMBODIMENTS

In the technique of Patent Document 1, an impact at the time of dropping is applied to the switch via the pressing surface, and thus the impact resistance of the switch cannot be improved. In addition, in the technique of Patent Document 1, there is a possibility that the accuracy of pressing the switch may be decreased due to the occurrence of displacement between the pressing member and the switch.

According to a pressing operation body of one embodiment of the present disclosure, while an overstroke operation exceeding a predetermined amount of movement of a switch is enabled, the impact resistance of the switch can be improved and also the accuracy of pressing the switch can be improved.

An embodiment will be described below with reference to the drawings. In the following description, for the sake of convenience, a Z-axis direction in the drawings is referred to as an up-down direction, a Y-axis direction in the drawings is referred to as a left-right direction, and an X-axis direction in the drawings is referred to as a front-rear direction. A positive Z-axis direction is referred to as an upward direction, a positive Y-axis direction is referred to as a rightward direction, and a positive X-axis direction is referred to as a frontward direction.

### (Configuration of Switch Module 10)

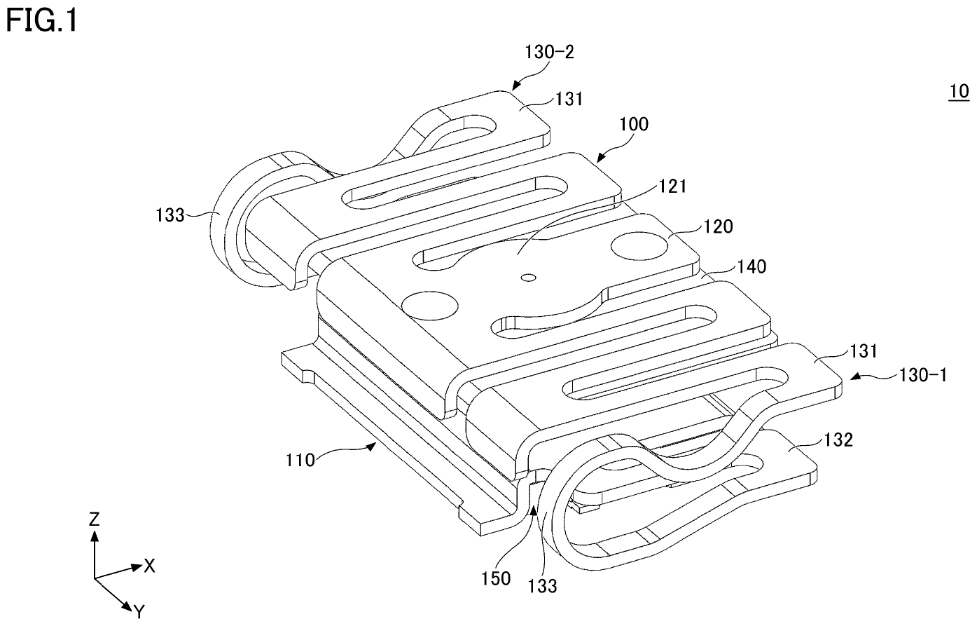

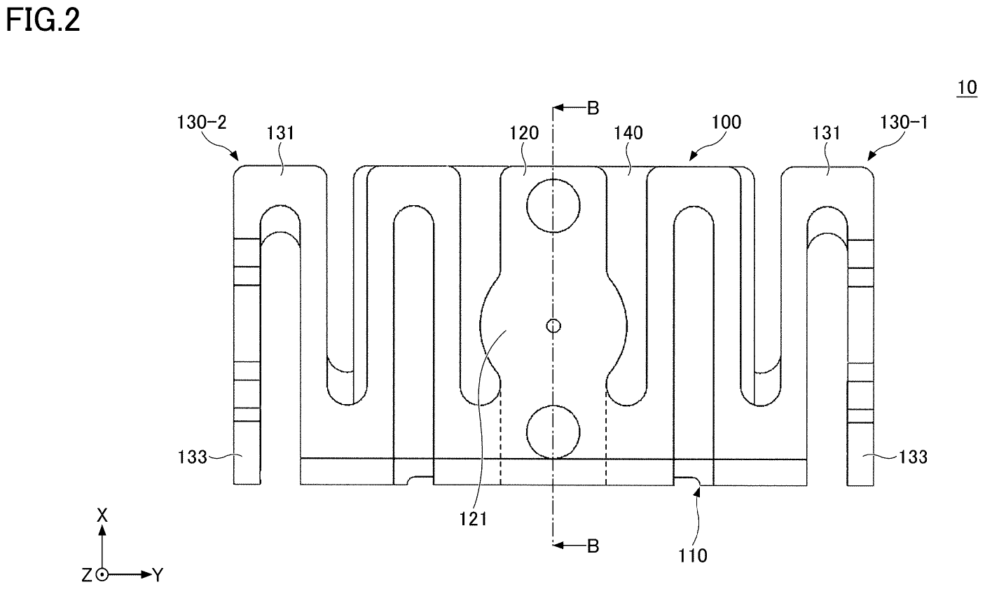

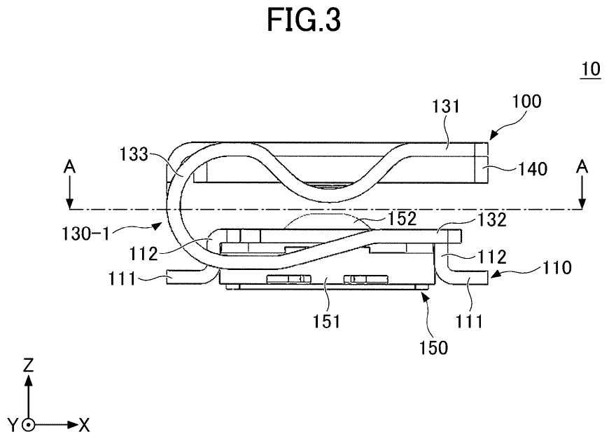

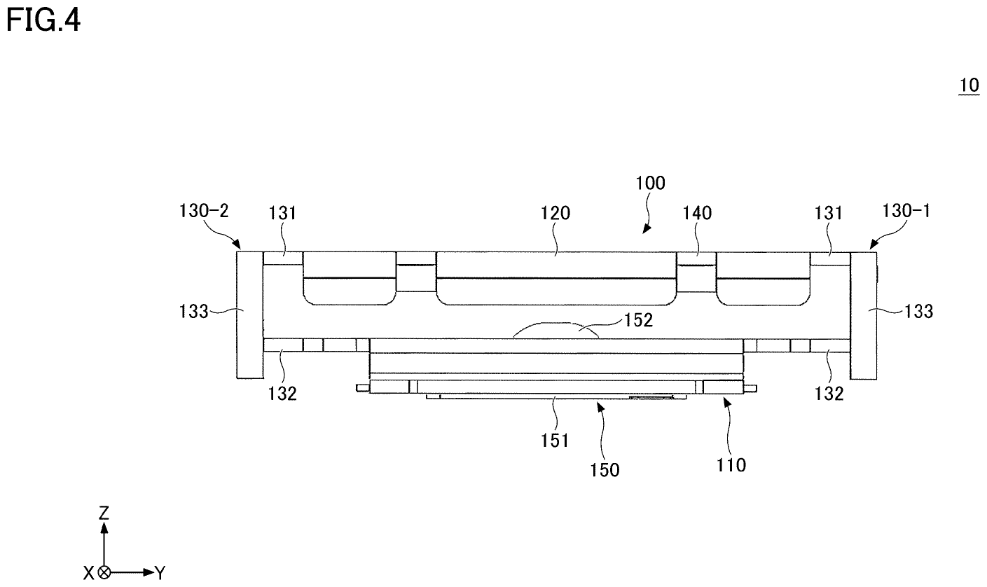

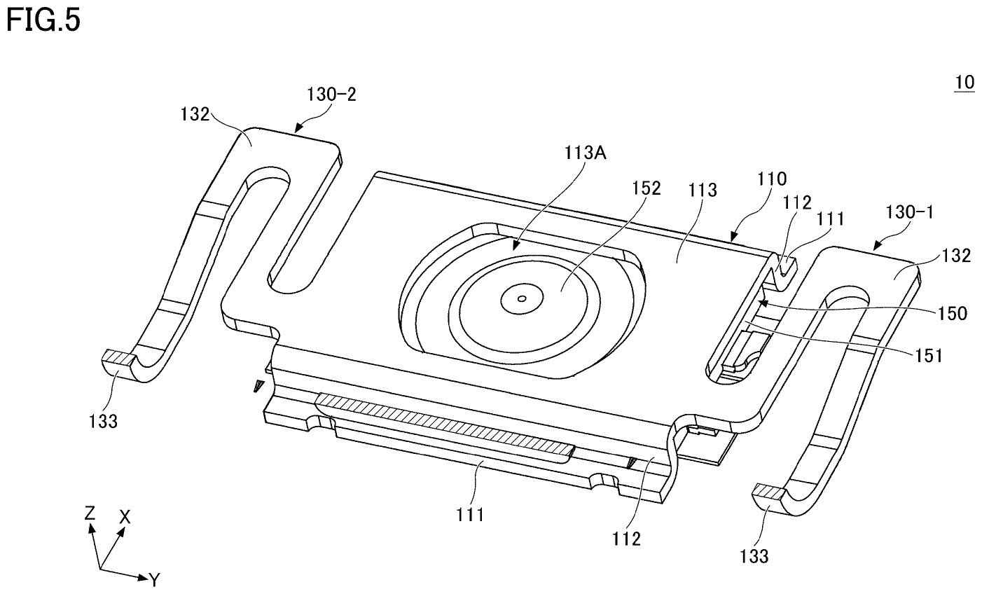

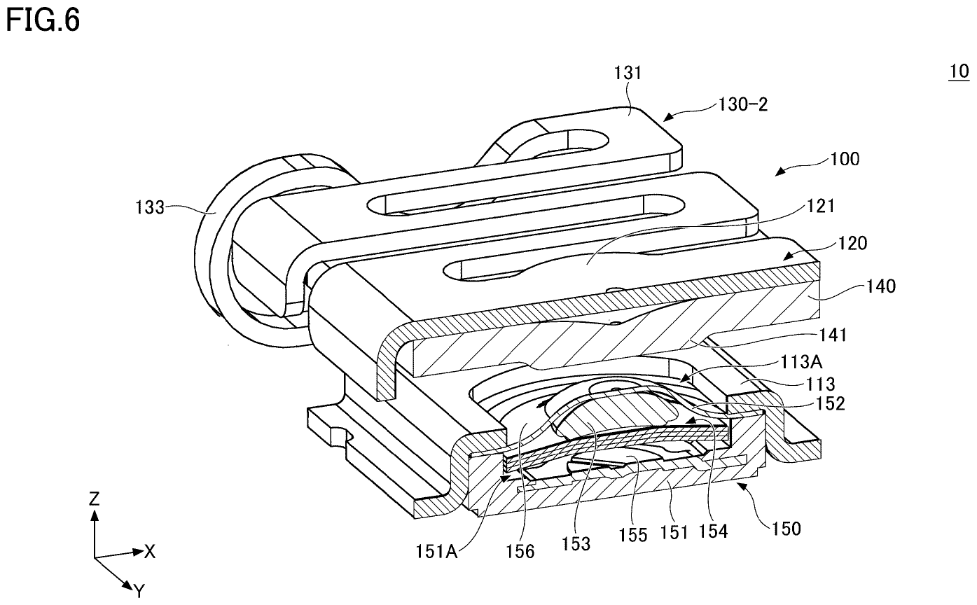

FIG. 1 is a perspective view of the exterior of a switch module 10 according to an embodiment. FIG. 2 is a plan view of the switch module 10 according to the embodiment. FIG. 3 is a right side view of the switch module 10 according to the embodiment. FIG. 4 is a rear view of the switch module 10 according to the embodiment. FIG. 5 is a cross-sectional view of the switch module 10 according to the embodiment, taken along line A-A of FIG. 3. FIG. 6 is a cross-sectional view of the switch module 10 according to the embodiment, taken along line B-B of FIG. 2.

As illustrated in FIG. 1 to FIG. 6, the switch module 10 includes a pressing operation body 100 composed of a metal material, and a switch 150. The switch module 10 has a two-tier configuration including an upper tier and a lower tier in the up-down direction (Z-axis direction). The switch module 10 is configured such that, when a top part 120 of the pressing operation body 100 provided on the upper tier is pressed, the top part 120 presses a pressing part 152 of the switch 150 provided on the lower tier, thereby causing the switch 150 to be turned on. For example, the switch module 10 is mounted on any of various electronic devices (for example, a smart watch and the like).

The pressing operation body 100 includes a base 110, a pair of elastic arms 130-1 and 130-2, the top part 120, and a reinforcing member 140.

The pressing operation body 100 is composed of one metal plate material, except for the reinforcing member 140. That is, the base 110, the pair of elastic arms 130-1 and 130-2, and the top part 120 are integrally formed. Accordingly, the pressing operation body 100 according to the embodiment does not require assembly work, and thus an assembly error does not occur.

The base 110 is provided on the lower tier of the switch module 10, and serves as the foundation of the pressing operation body 100. As illustrated in FIG. 5, the base 110 includes a pair of landing portions 111, a pair of wall portions 112, and a contact surface 113.

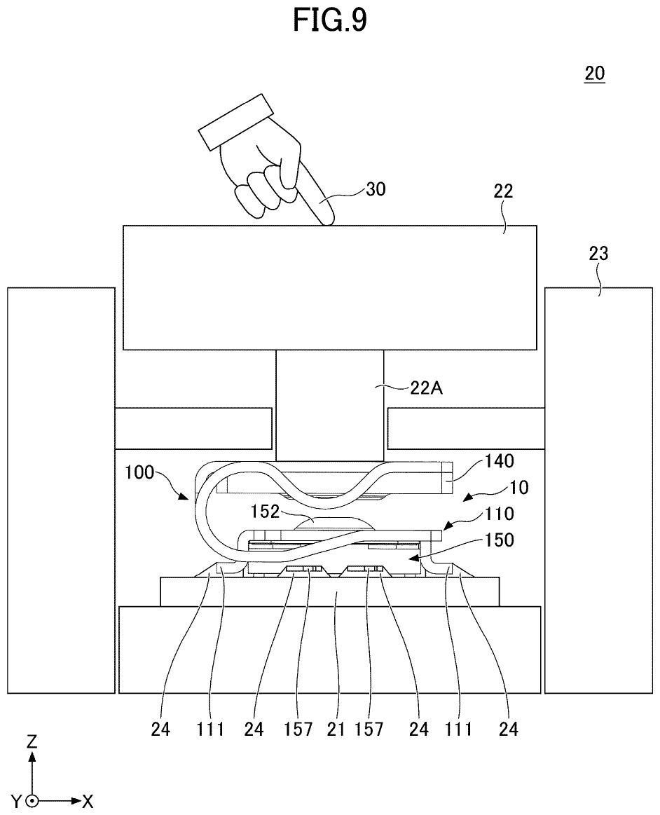

The landing portions 111 are elongated portions having a horizontal flat plate shape and extending in the left-right direction (Y-axis direction) along the front edge and the rear edge of the contact surface 113. The back surface of each of the pair of landing portions 111 can be fixed to a circuit board 21 included in an electronic device 20 (see FIG. 9) by any fixing method (for example, solder or the like).

Each of the pair of the wall portions 112 is a vertical wall-shaped portion extending upward from the inner edge of a corresponding landing portion 111 of the pair of landing portions 111. The pair of wall portions 112 support the front edge and the rear edge of the contact surface 113.

The contact surface 113 is a rectangular portion having a horizontal flat plate shape in a plan view from above. The contact surface 113 has an opening 113A at the center.

That is, as illustrated in FIG. 3, the base 110 has a projecting shape protruding upward in a side view from the left-right direction (Y-axis direction).

As illustrated in FIG. 5, the elastic arm 130-1 and the elastic arm 130-2 extend from a right end portion and a left end portion of the contact surface 113, respectively. Accordingly, the base 110 supports end portions on the lower tier side of the pair of elastic arms 130-1 and 130-2.

The pair of elastic arms 130-1 and 130-2 are provided on respective outer sides of the top part 120 in the left-right direction (Y-axis direction). The elastic arm 130-1 is provided on the right outer side of the top part 120. The elastic arm 130-2 is provided on the left outer side of the top part 120. Further, the pair of elastic arms 130-1 and 130-2 are symmetrically arranged with respect to the top part 120.

Accordingly, in the switch module 10 according to the embodiment, when the top part 120 is pressed, the pair of elastic arms 130-1 and 130-2 can elastically deform equally on the respective outer sides of the top part 120. Therefore, inclination of the top part 120 can be suppressed, and thus the accuracy of pressing the switch 150 by the pressing operation body 100 can be improved.

Each of the pair of elastic arms 130-1 and 130-2 is formed in a single strip shape continuous from the contact surface 113 of the base 110 to the top part 120. That is, the end portions on the lower tier side of the pair of elastic arms 130-1 and 130-2 are connected to the contact surface 113 of the base 110, and end portions on the upper tier side of the pair of elastic arms 130-1 and 130-2 are connected to the top part 120. Accordingly, each of the pair of elastic arms 130-1 and 130-2 supports the top part 120 while being supported by the base 110. Each of the pair of elastic arms 130-1 and 130-2 has a spring characteristic and is elastically deformable so as to move the top part 120 downward.

Specifically, each of the pair of elastic arms 130-1 and 130-2 includes an upper turnaround portion 131 provided on the upper tier of the switch module 10 (that is, the outer side of the top part 120), a lower turnaround portion 132 provided on the lower tier of the switch module 10 (that is, the outer side of the contact surface 113 of the base 110), and a coupling portion 133 that couples the upper turnaround portion 131 and the lower turnaround portion 132.

The upper turnaround portion 131 has a structure in which a plurality of (in the present embodiment, four) straight portions extending in a straight shape in the front-rear direction (X-axis direction) are arranged side by side in the left-right direction (Y-axis direction). Similarly, the lower turnaround portion 132 has a structure in which a plurality of (in the present embodiment, two) straight portions extending in a straight shape in the front-rear direction (X-axis direction) are arranged side by side in the left-right direction (Y-axis direction).

The coupling portion 133 couples an end portion of the upper turnaround portion 131 and an end portion of the lower turnaround portion 132 in the up-down direction, and has a curved shape projecting toward the rear side (the negative X-axis side) in a side view.

Accordingly, in the switch module 10 according to the embodiment, each of the pair of elastic arms 130-1 and 130-2 can have a relatively long spring length without the entire size of the switch module 10 being increased.

The top part 120 is a horizontal flat plate-shaped part provided on the upper tier of the switch module 10. Specifically, the top part 120 is provided above the base 110 and at the center of the base 110 in the left-right direction (Y-axis direction). The top part 120 has a substantially rectangular shape in a plan view from above, with the longer side being in the front-rear direction (X-axis direction). Further, the top part 120 has a central portion 121 having a circular shape in a plan view from above. Accordingly, the top part 120 has a shape in which the central portion 121 protrudes outward relative to the long sides of the rectangular shape. Further, the end portions on the upper tier side of the pair of elastic arms 130-1 and 130-2 are connected to left and right end portions of the top part 120. With this configuration, the top part 120 is supported by the pair of elastic arms 130-1 and 130-2. The top part 120 is movable toward the base 110 (that is, downward) by being pressed while causing the pair of elastic arms 130-1 and 130-2 to be elastically deformed.

The reinforcing member 140 is provided on the upper tier of the switch module 10 and reinforces the top part 120. Specifically, the reinforcing member 140 is a horizontal flat plate-shaped member provided on the lower side of the top part 120. The reinforcing member 140 is fixed to the bottom surface of the top part 120 by any fixing method. As an example, in the present embodiment, the reinforcing member 140 is fixed to the bottom surface of the top part 120 by laser welding. However, the reinforcing member 140 may be fixed to the bottom surface of the top part 120 by any other fixing method (for example, an adhesive, a double-sided tape, or the like).

The reinforcing member 140 has a substantially square shape larger than the top part 120 in a plan view from above. The reinforcing member 140 is formed of a relatively hard material (for example, a resin material, a metal material, or the like) so as not to elastically deform. With this configuration, when the top part 120 is pressed, the reinforcing member 140 can suppress elastic deformation of the top part 120 while moving downward together with the top part 120. That is, the reinforcing member 140 can move the top part 120 downward without causing elastic deformation of the top part 120 while maintaining the horizontal flat plate shape of the top part 120. A projection 141 is provided at the center of the bottom surface of the reinforcing member 140. The projection 141 is provided above the pressing part 152 of the switch 150, and presses the pressing part 152 of the switch 150 when the top part 120 is pressed.

The switch 150 is provided under the contact surface 113 of the base 110 of the pressing operation body 100. Further, the switch 150 is sandwiched between the pair of wall portions 112 of the base 110 of the pressing operation body 100. The switch 150 includes a housing 151 and the pressing part 152 protruding upward from the center of the upper surface of the housing 151. The pressing part 152 is exposed through the opening 113A of the contact surface 113, and is pressed by the top part 120 when the top part 120 is pressed.

An internal configuration of the switch 150 is illustrated in FIG. 6. In a recessed space 151A of the housing 151, the switch 150 includes a pressing body 153 and a metal contact 154 (an example of a “movable contact”) formed of a plurality of metal plates stacked on top of each other. Further, the switch 150 includes a thin sheet-shaped insulator 156 that covers the space 151A of the housing 151. The pressing part 152 of the switch 150 is formed by a portion of the insulator 156 being raised by the pressing body 153 that adheres to the back surface of the insulator 156.

In the switch 150, when the pressing part 152 is pressed, the pressing body 153 provided inside the pressing part 152 presses down the top of the metal contact 154, thereby causing the top of the metal contact 154 to be elastically deformed (inverted) into a recessed shape. As a result, the back side of the top of the metal contact 154 contacts a central fixed contact 155 (an example of a “fixed contact”) provided on the bottom surface of the space 151A of the housing 151. As a result, the switch 150 is switched from an off state to an on state.

In the switch module 10 according to the embodiment, the switch 150 is provided integrally with the pressing operation body 100 by being sandwiched between the pair of wall portions 112 of the pressing operation body 100. With this configuration, the switch module 10 according to the embodiment can easily handle the switch 150 and the pressing operation body 100 integrally. In addition, the switch module 10 according to the embodiment can suppress displacement of the pressing operation body 100 with respect to the switch 150. As a result, the switch module 10 according to the embodiment allows the center of the pressing part 152 of the switch 150 to be reliably pressed (vertically from directly above) by the top part 120 of the pressing operation body 100. Accordingly, the accuracy of pressing the switch 150 by the pressing operation body 100 can be improved.

### (Operation of Switch Module 10)

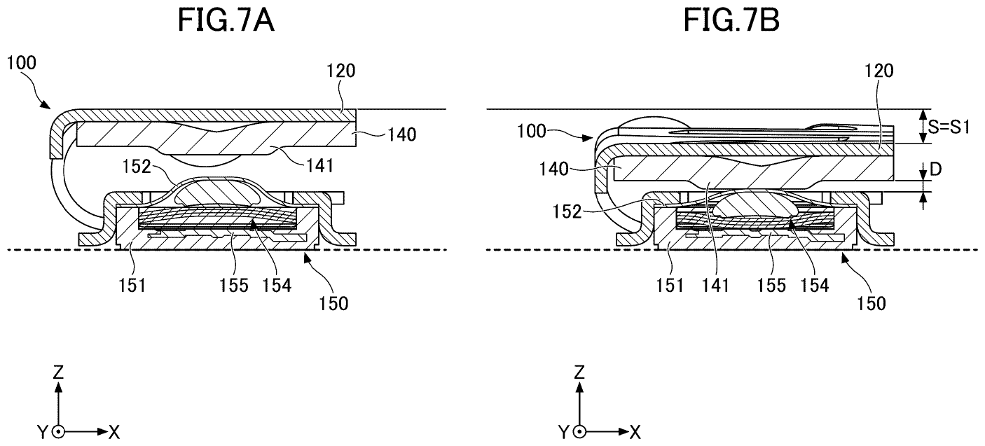

FIGS. 7A and 7B are diagrams illustrating the operation of the switch module 10 according to the embodiment.

In the switch module 10 according to the embodiment, as illustrated in FIG. 7A, when the top part 120 of the pressing operation body 100 is not pressed, the top part 120 of the pressing operation body 100 is separated upward from the pressing part 152 of the switch 150 by a predetermined distance.

Then, in the switch module 10 according to the embodiment, as illustrated in FIG. 7B, when the top part 120 of the pressing operation body 100 is pressed, the top part 120 of the pressing operation body 100 moves downward together with the reinforcing member 140 while the pair of elastic arms 130-1 and 130-2 of the pressing operation body 100 are elastically deformed. At this time, when a stroke amount S of the top part 120 of the pressing operation body 100 reaches a predetermined amount S1, the projection 141 provided on the bottom surface of the reinforcing member 140 of the pressing operation body 100 presses the pressing part 152 of the switch 150. As a result, the metal contact 154 is inverted and contacts the central fixed contact 155 within the housing 151, and the switch 150 is switched from an off state to an on state.

As illustrated in FIG. 7B, when the stroke amount S of the top part 120 of the pressing operation body 100 is the predetermined amount S1, the switch module 10 according to the embodiment has a gap D between the bottom surface of the reinforcing member 140 and the contact surface 113 of the base 110. Therefore, the switch module 10 according to the embodiment can further press down the top part 120 of the pressing operation body 100 by an amount equal to the gap D.

At this time, the pressing part 152 of the switch 150 is further pressed by the projection 141 of the reinforcing member 140, thereby enabling what is known as an overstroke operation (an operation of allowing the switch 150 to be further pressed beyond a predetermined amount of movement while keeping the on state).

In the switch module 10 according to the embodiment, upon the top part 120 of the pressing operation body 100 being further pressed down by the amount equal to the gap D, the bottom surface of the reinforcing member 140 of the pressing operation body 100 contacts the contact surface 113 of the base 110. As a result, further pressing-down of the top part 120 of the pressing operation body 100 (that is, by an amount greater than the gap D) is restricted.

As a result, the switch module 10 according to the embodiment can regulate the amount of the overstroke operation of the switch 150 to the amount equal to the gap D. Therefore, the switch module 10 according to the embodiment can suppress an impact load to be applied to the switch 150 when the switch module 10 is dropped or the like, and thus can improve the impact resistance of the switch 150 while allowing the overstroke operation of the switch 150.

In the switch module 10 according to the embodiment, when the pressing of the top part 120 of the pressing operation body 100 is released, the pressing operation body 100 returns to the initial state illustrated in FIG. 7A by elastic forces of the pair of elastic arms 130-1 and 130-2. As a result, the metal contact 154 is separated from the central fixed contact 155 within the housing 151, and the switch 150 is switched from the on state to the off state.

### (Configuration of Bottom Surface of Switch Module 10)

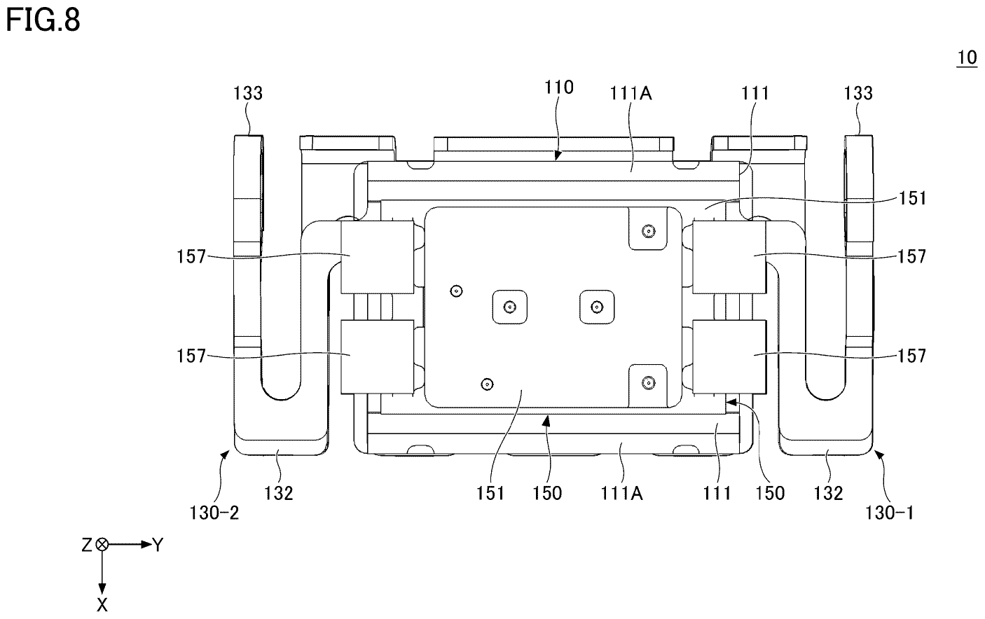

FIG. 8 is a bottom view of the switch module 10 according to the embodiment.

As illustrated in FIG. 8, the switch 150 includes four external connection terminals 157 each having a horizontal flat plate shape on the bottom surface of the housing 151. Each of the four external connection terminals 157 of the switch 150 can be fixed to the circuit board 21 of the electronic device 20 by solder 24.

With this configuration, in the switch module 10 according to the embodiment, the switch 150 can be fixed to the circuit board 21 of the electronic device 20 by the solder 24 at the four external connection terminals 157 each having a relatively large area.

Further, as illustrated in FIG. 8, the pressing operation body 100 includes the pair of landing portions 111 with the switch 150 sandwiched therebetween in the front-rear direction (X-axis direction). The pair of landing portions 111 have respective elongated bottom surfaces 111A each having a horizontal flat plate shape and extending in the left-right direction (Y-axis direction). The bottom surfaces 111A of the pair of landing portions 111 of the pressing operation body 100 can be fixed to the circuit board 21 of the electronic device 20 by solder 24.

Accordingly, in the switch module 10 according to the embodiment, the pressing operation body 100 can be fixed to the circuit board 21 of the electronic device 20 by the solder 24 at the bottom surfaces 111A of the pair of landing portions 111 each having a relatively large area.

As a result, the switch module 10 according to the embodiment allows the circuit board 21 to reliably receive an impact load applied to the pressing operation body 100, and thus can inhibit the impact load from being applied to the switch 150.

### (Configuration of Electronic Device 20)

FIG. 9 is a diagram illustrating an example of a configuration of the electronic device 20 according to the embodiment.

As illustrated in FIG. 9, the electronic device 20 includes the switch module 10, the circuit board 21 (an example of an “installation part”) on which the switch module 10 is to be mounted, an intervening member 22, and a housing 23. The switch module 10 and the circuit board 21 are provided within the housing 23.

In the electronic device 20, as described with reference to FIG. 8, the external connection terminals 157 of the switch 150 and the landing portions 111 of the pressing operation body 100 are fixed to the circuit board 21 by the solder 24 in the switch module 10.

The intervening member 22 is provided on the upper side of the top part 120 of the pressing operation body 100 and on the upper side of an upper wall portion of the housing 23, and is composed of a conductor. The intervening member 22 includes a projection 22A having a shape protruding downward. The projection 22A is provided so as to pass through the upper wall portion of the housing 23 and press the top part 120 of the pressing operation body 100.

In the electronic device 20, the projection 22A of the intervening member 22 presses down the top part 120 of the pressing operation body 100 in response to the intervening member 22 being pressed down by an operation body 30 (for example, a hand) of an operator. Accordingly, the top part 120 of the pressing operation body 100 presses the pressing part 152 of the switch 150. As a result, the switch 150 is switched from an off state to an on state.

The intervening member 22 is formed of a conductor, and can detect a small amount of current that is generated by the operation body 30 (living body) touching the intervening member 22. The current detected by the intervening member 22 flows into the circuit board 21 via the pressing operation body 100. Thus, the electronic device 20 can cause a microcomputer provided on the circuit board 21 to measure a myoelectric potential of the operation body 30 by using the current detected by the intervening member 22.

In the electronic device 20 according to the embodiment using the switch 150 according to the embodiment, an impact load to be applied to the switch 150 via the intervening member 22 when the electronic device 20 is dropped or the like can be suppressed. Thus, the durability of the switch 150 can be improved.

Further, in the electronic device 20 according to the embodiment, the pressing operation body 100 is fixed to the circuit board 21 of the electronic device 20 with the solder 24 at the bottom surfaces 111A of the pair of landing portions 111 each having a relatively large area in the switch module 10.

Accordingly, the electronic device 20 according to the embodiment allows the circuit board 21 to reliably receive an impact load applied to the pressing operation body 100 via the intervening member 22, and thus can inhibit the impact load from being applied to the switch 150.

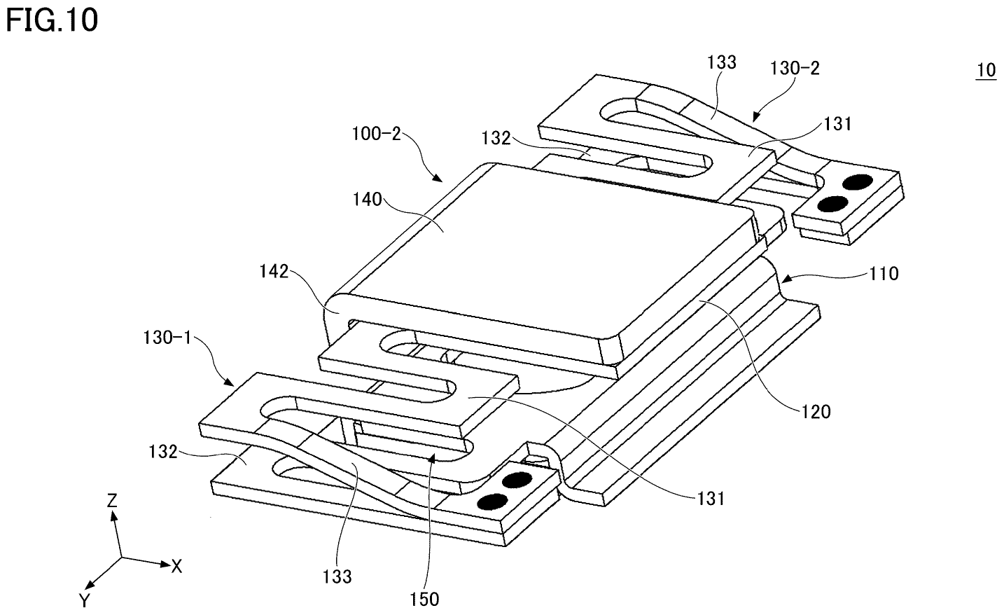

FIG. 10 is a perspective view of the exterior of a switch module 10 according to a modification of the embodiment.

The switch module 10 illustrated in FIG. 10 includes a pressing operation body 100-2 instead of the pressing operation body 100. With respect to the pressing operation body 100-2, differences from the pressing operation body 100 will be described below.

In the pressing operation body 100-2, an upper turnaround portion 131 of each of a pair of elastic arms 130-1 and 130-2 is formed integrally with a top part 120 and a coupling portion 133, and a lower turnaround portion 132 is formed integrally with a base 110. That is, the pressing operation body 100-2 is composed of two metal plate materials.

In addition, in the pressing operation body 100-2, the coupling portion 133 has a linear shape in a plan view from above, and is inclined downward from the rear end (the end on the negative X-axis side) to the front end (the end on the positive X-axis side). Further, the front end of the coupling portion 133 overlaps the upper side of an end portion of the lower turnaround portion 132, and is connected to the end portion of the lower turnaround portion 132 by any fixing method.

As described above, each of the pair of elastic arms 130-1 and 130-2 can be any member as long as each of the pair of elastic arms 130-1 and 130-2 can move the top part 120 downward by being at least elastically deformed, and the shape, the configuration, and the like of each of the pair of elastic arms 130-1 and 130-2 can be variously modified.

In addition, in the pressing operation body 100-2, the top part 120 has a substantially square shape in a plan view.

In addition, in the pressing operation body 100-2, a reinforcing member 140 has a substantially square shape, extends slightly rearward (toward the negative X-axis side) relative to the top part 120 in a plan view, and is provided on the upper side of the top part 120.

Further, in the pressing operation body 100-2, the reinforcing member 140 includes a bent portion 142 that is bent at a right angle downward from a rear end portion (end portion on the negative X-axis side) of the reinforcing member 140 extending rearward relative to the top part 120, and, as a result, the strength is increased.

As described above, the reinforcing member 140 may be any member that reinforces at least the top part 120, and the arrangement position, the shape, and the like of the reinforcing member 140 may be variously modified.

The reinforcing member 140 is not necessarily a separate member from the top part 120, and may be formed by bending a portion of the top part 120, for example.

Although one embodiment of the present disclosure has been described in detail above, the present disclosure is not limited to the above-described embodiment, and various changes or modifications can be made within the scope of the present disclosure as described in the claims.

What is claimed is:

1. A pressing operation body composed of a metal material, the pressing operation body comprising:
a base;
an elastic arm connected to the base; and
a top part provided above the base, supported by the elastic arm, and configured to be movable toward the base by being pressed, wherein
the base includes
a landing portion configured to be fixed to an installation part on which the pressing operation body is to be installed,
a wall portion extending upward from the landing portion, and
a contact surface supported by the wall portion from below and configured to contact the top part when the top part is pressed.

2. The pressing operation body according to claim 1, wherein the elastic arm includes a pair of elastic arms provided on respective outer sides of the top part.

3. The pressing operation body according to claim 2, wherein the pair of elastic arms are symmetrically arranged with respect to the top part.

4. The pressing operation body according to claim 1, wherein the elastic arm extends from an end portion of the contact surface.

5. The pressing operation body according to claim 1, further comprising:
a reinforcing member that reinforces the top part.

6. The pressing operation body according to claim 5, wherein the reinforcing member is formed by bending a portion of the top part.

7. The pressing operation body according to claim 1, wherein the pressing operation body is composed of one metal plate material.

8. The pressing operation body according to claim 1, wherein the installation part is a circuit board.

9. A switch module comprising:
the pressing operation body of claim 1; and
a switch including a housing, a fixed contact, and a movable contact, the fixed contact and the movable contact being accommodated within the housing, wherein
the wall portion of the pressing operation body includes a pair of wall portions, and
the switch is provided under the contact surface and is sandwiched between the pair of wall portions of the pressing operation body.

10. The switch module according to claim 9, wherein
the contact surface of the pressing operation body has an opening at a center thereof,
the switch includes a pressing part protruding upward, and
the pressing part is exposed through the opening, and is pressed by the top part when the top part is pressed.

11. The switch module according to claim 10, wherein
the pressing operation body includes a projection provided above the pressing part and protruding downward, and
the pressing part is pressed by the projection when the top part is pressed.

12. An electronic device comprising:
the switch module of claim 10; and
a circuit board on which the switch module is to be mounted, wherein
an external connection terminal of the switch and the landing portion of the pressing operation body are fixed to the circuit board by solder.

13. The electronic device according to claim 12, further comprising:
an intervening member provided on an upper side of the top part, composed of a conductor, and configured to press the top part by being pressed by an operator.
